(19) United States
(12) Patent Application Publication
(10) Pub. No.: US 2009/0040959 A1
(43) Pub. Date: Feb. 12, 2009

(54) METHOD AND SYSTEM FOR RETRANSMITTING DATA IN A COMMUNICATION SYSTEM

(75) Inventors: Young-Ho JUNG, Suwon-si (KR); Eun-Yong KIM, Osan-si (KR); Jung-Hoon CHEON, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/185,460

(22) Filed: Aug. 4, 2008

(30) Foreign Application Priority Data
Aug. 8, 2007 (KR) 2007-79433

(51) Int. Cl. H04H 20/71; H04B 7/26

(52) U.S. Cl. 370/312

(57) ABSTRACT

A method and system for retransmitting data in a communication system are provided. In the retransmission method, a BS determines an automatic retransmission number for a multicast data frame according to the number of MSs of a multicast group, transmits the determined automatic retransmission number to the MSs of the multicast group, and repeatedly transmits the multicast data frame to the MSs until the number of transmissions of the multicast data frame is equal to the automatic retransmission number, irrespective of reception of information indicating whether the multicast data frame has been received from the MSs. Accordingly, resource consumption can be reduced and overhead can be decreased.

### PRIORITY

This application claims the benefit under 35 U.S.C. §119(a) of a Korean patent application filed in the Korean Intellectual Property Office on Aug. 8, 2007 and assigned Serial No. 2007-79433, the entire disclosure of which is hereby incorporated by reference.

### BACKGROUND OF THE INVENTION

1. Field of the Invention

The present invention relates to a method and system for retransmitting data in a communication system. More particularly, the present invention relates to a method and system for retransmitting data in a communication system using a multicast transmission scheme.

2. Description of the Related Art

A communication system can transmit data in a unicast scheme or a multicast scheme. A multicast scheme is a transmission scheme in which a Base Station (BS) transmits the same data frame to two or more particular Mobile Stations (MSs).

In the multicast communication system, the BS transmits the data frame using a coding rate set for an MS in the worst channel status among the MSs of a multicast group in order to ensure the reliability of the data transmission. When an MS of the multicast group fails to receive the data frame, the BS retransmits it.

With reference to FIGS. 1 and 2, an operation for retransmitting a data frame in a BS in a conventional multicast communication system will be described. In the following description, a group of particular MSs to which the BS transmits the same data frame simultaneously is defined as a multicast group. While only a single MS is shown in FIG. 1 for convenience sake, it is to be appreciated that the MS can be any of the MSs within the multicast group and thus it is denoted by MSn.

FIG. 1 is a diagram illustrating a signal flow for a data frame retransmission operation of a BS in a conventional multicast communication system.

Referring to FIG. 1, a BS 103 transmits a K^{t} data frame to an MS 101 (MSn) in step 105. MSn determines whether it has received the K^{th} data frame successfully in step 107. The determination, made upon receipt of the K^{th} data frame, includes evaluating whether the K^{th} data frame has been received and evaluating whether the K^{th} data frame has errors. The error check can be performed by use of a Cyclic Redundancy Check (CRC).

If MSn has failed to receive the K^{th} data frame, it transmits a Negative ACKnowledgment (NACK) signal to the BS 103, which includes a request for retransmission of the K^{th} data frame in step 109. Upon receipt of the NACK signal, the BS 103 retransmits the K^{th} data frame to MSn in step 111.

MSn determines whether it has received the retransmitted K^{th} data frame successfully in step 113. If the reception is successful, MSn transmits an ACKnowledgment (ACK) signal to the BS 103 in step 115. Upon receipt of the ACK signal, the BS 103 transmits the next frame, i.e. a (K+1)^{th} data frame to MSn in step 117. On the other hand, if it is determined that the reception failed in step 113, MSn transmits a NACK signal to the BS 103, requesting retransmission of the K^{th} data frame.

The above description includes the context that the BS 103 receives an ACK signal from MSn upon which receipt the BS 103 transmits the next data frame. In addition, if the BS 103 has not received a NACK signal from MSn for a system-set time period, it can transmit the next data frame, i.e. the (K+1)^{th} data frame to MSn, considering that the transmission of the K^{th} data frame was successful.

FIG. 2 is a flowchart illustrating a data frame retransmission operation of a BS in a conventional multicast communication system.

Referring to FIG. 2, the BS transmits the K^{th} data frame to MSn, i.e. all MSs of the multicast group in step 201 and monitors for reception of a NACK signal from MSn for the system-set time period in step 203. Upon receipt of a NACK signal within the time period, the BS retransmits the K^{th} data frame to MSn in step 201.

Meanwhile, if the BS has not received a NACK signal within the time period in step 203, it transmits the next data frame, i.e. the (K+1)^{th} data frame in step 205.

In the conventional multicast communication system, as additional MSs are included in a multicast group, the probability of a failed reception of a data frame at one of the MSs increases.

To ensure the reception reliability of a data frame, the BS retransmits the data frame to all MSs of the multicast group if it receives a NACK signal from one MS of the multicast group. Because the BS must wait until the reception of the NACK signal from the MS to retransmit the data frame, the time delay leads to resource consumption.

Moreover, an increased probability of failed reception at an MS increases the amount of feedback information, i.e. ACK/NACK information transmitted to the BS, thereby resulting in an increased overhead.

### SUMMARY OF THE INVENTION

An aspect of the present invention is to address at least the above-mentioned problems and/or disadvantages and to provide at least the advantages described below. Accordingly, an aspect of the present invention is to provide a method and system for retransmitting a data frame in a multicast communication system.

Another aspect of the present invention is to provide a method and system for automatically retransmitting a data frame according to a retransmission number irrespective of whether an ACK signal is received in a multicast communication system.

In accordance with an aspect of the present invention, a method for transmitting data in a BS in a communication system is provided. The method includes determining an automatic retransmission number for a multicast data frame according to the number of MSs of a multicast group, transmitting the determined automatic retransmission number to the MSs of the multicast group, and repeatedly transmitting the multicast data frame to the MSs until the number of transmissions of the multicast data frame is equal to the automatic retransmission number.

In accordance with another aspect of the present invention, a method for receiving data in an MS in a communication system is provided. The method includes receiving an automatic retransmission number from a BS, receiving a multicast data frame repeatedly from the BS, and transmitting a NACK signal to the BS if the reception of the multicast data frame is not successful, after receiving the multicast data frame repeatedly until the number of receptions of the multicast data frame is equal to the automatic retransmission number.

In accordance with a further aspect of the present invention, a communication system having a BS and MSs of a multicast group is provided. In the communication system, the BS determines an automatic retransmission number for a multicast data frame according to the number of the MSs of the multicast group, transmits the determined automatic retransmission number to the MSs of the multicast group, and repeatedly transmits the multicast data frame to the MSs until the number of transmissions of the multicast data frame is equal to the automatic retransmission number.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a diagram illustrating a signal flow for a data frame retransmission operation of a BS in a conventional multicast communication system;

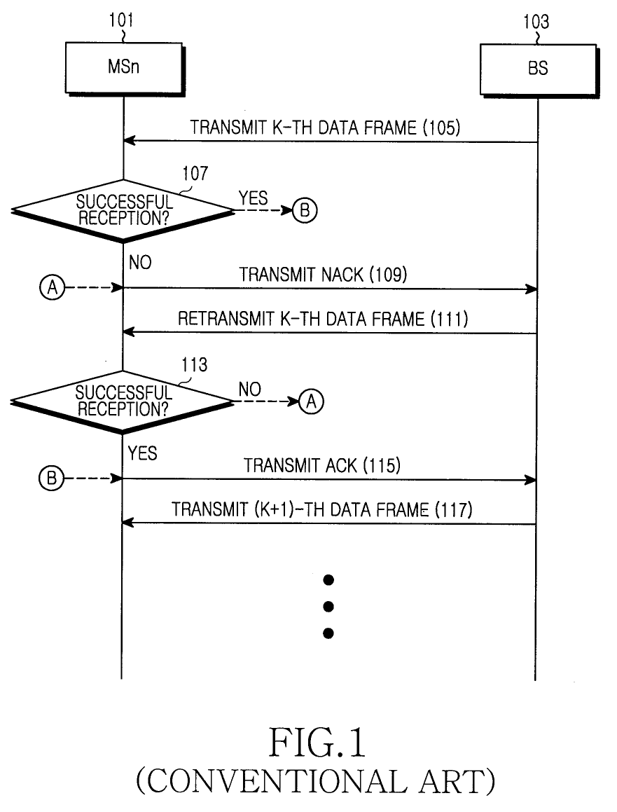

FIG. 2 is a flowchart illustrating a data frame retransmission operation of a BS in a conventional multicast communication system;

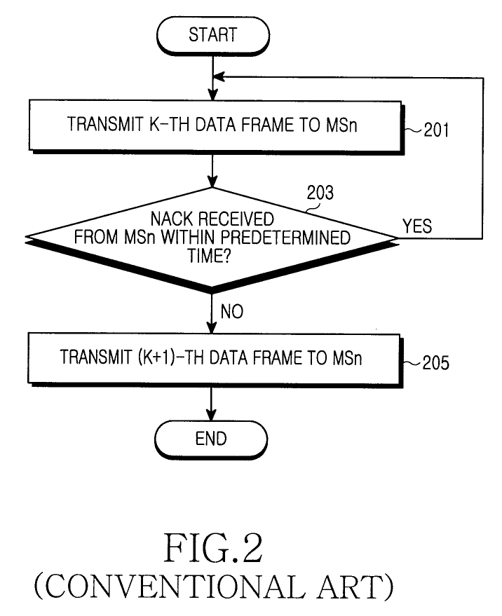

FIG. 3 is a diagram illustrating a signal flow for a data frame retransmission operation of a BS in a multicast communication system according to an exemplary embodiment of the present invention;

FIG. 4 is a flowchart illustrating a data frame retransmission operation of a BS in a multicast communication system according to an exemplary embodiment of the present invention; and

FIG. 5 is a flowchart illustrating a data reception operation of MSn in a multicast communication system according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Exemplary embodiments of the present invention provide a method and system for retransmitting data in a multicast communication system. Especially, exemplary embodiments of the present invention provide a method and system for automatically retransmitting a data frame according to a predetermined retransmission number irrespective of reception of a NACK signal in a multicast communication system.

Before describing exemplary embodiments of the present invention, a multicast will be described in brief. Multicast is a transmission scheme in which a BS transmits the same data frame to two or more particular MSs. Herein, a group of particular MSs to which the BS transmits the same data frame simultaneously is defined as a multicast group.

A description will now be made of a method for determining a number of retransmissions of a data frame to minimize resource consumption in a multicast communication system. For a better understanding of the present invention, ‘a transmission number of a data frame determined for minimization of resource consumption’ is referred to as ‘an automatic retransmission number’. In accordance with exemplary embodiments of the present invention, a BS repeatedly transmits a data frame to MSs of a multicast group as many times as the automatic retransmission number irrespective of reception of a NACK signal, so as to address the problems of time delay and resource consumption involved in waiting for NACK reception. For example, given an automatic retransmission number of 2, the BS transmits a data frame twice to the multicast group and, upon receipt of a NACK signal corresponding to the data frame, retransmits the data frame.

The automatic retransmission number can be fixed or variable.

The fixed automatic retransmission number is set by the system. In an exemplary implementation, the variable automatic retransmission number is determined according to the number of MSs in a multicast group, their channel status, and a target Frame Error Rate (FER). Instead of the target FER, a Bit Error Rate (BER) or a Symbol Error Rate (SER) can be used depending on the unit of transmitted data.

In a Hybrid Automatic Repeat reQuest (HARQ) communication system, the probability that receipt of a transmitted data frame has failed at an MS despite n repeated transmissions (n is an automatic retransmission number), that is, the probability of transmitting a NACK signal from any MS to the BS, is given in equation (1). In equation (1), the target FER is ρ and is identical for all MSs.

Pr(NACK)=1−(1−ρ)^{ρ}^{^{n−1}}^{K} (1)

where ρ is the target FER, n is the repeated transmission number, and K is the total number of MSs in the multicast group or the number of MSs in good channel status among the MSs of the multicast group (i.e. the number of MSs having Channel Quality Information (CQI) values equal to or higher than a threshold).

An exemplary embodiment of the present invention for determining an automatic retransmission number for each target FER according to Pr(NACK) in the multicast communication system will be described with reference to the following tables, specifically Table 1 to Table 4.

In accordance with an exemplary embodiment of the present invention, if the target FER is 1%, Pr(NACK) is given in Table 1 for different numbers of selected MSs based on CQI and retransmission numbers.

TABLE 1
Target FER 1%

(%)

| | |
|---|---|
| Number | Retransmission number |

| Of MSs | 0 | 1 | 2 | 3 | 4 |
|---|---|---|---|---|---|
| 3 | 95 | 3 | 0 | 0 | 0 |
| 5 | 99 | 5 | 0 | 0 | 0 |
| 10 | 100 | 10 | 0 | 0 | 0 |
| 20 | 100 | 18 | 0 | 0 | 0 |
| 30 | 100 | 26 | 0 | 0 | 0 |

The minimum automatic retransmission number corresponding to Pr(NACK) being equal to or less than the target FER is selected in the exemplary embodiment. Therefore, for the target FER of 1%, while retransmission numbers 1, 2, 3 and 4 all correspond to Pr(NACK) being equal to or less than the target FER of 1% (i.e. Pr(NACK)=0% for all number of MSs for each retransmission number 1, 2, 3 and 4), the minimum automatic retransmission number is 1 for 3, 5, 10, 20 and 30 MSs in Table 1 and therefore 2 is selected.

In accordance with another exemplary embodiment of the present invention, if the target FER is 10%, Pr(NACK) is given in Table 2, for numbers of selected MSs based on CQI and retransmission numbers.

TABLE 2
Target FER 10%

(%)

| | |
|---|---|
| Number | Retransmission number |

| Of MSs | 0 | 1 | 2 | 3 | 4 |
|---|---|---|---|---|---|
| 3 | 96 | 27 | 3 | 0 | 0 |
| 5 | 99 | 41 | 5 | 0 | 0 |
| 10 | 100 | 65 | 10 | 1 | 0 |
| 20 | 100 | 88 | 19 | 2 | 0 |
| 30 | 100 | 96 | 27 | 3 | 0 |

In Table 2, for the target FER of 10%, the automatic retransmission number is 2 for 3, 5, and 10 MSs and 3 for 20 and 30 MSs.

In accordance with a third exemplary embodiment of the present invention, if the target FER is 20%, Pr(NACK) is given in Table 3, for numbers of selected MSs based on CQI and retransmission numbers.

TABLE 3
Target FER 20%

(%)

| Number | Retransmission number | | | | | | |
|---|---|---|---|---|---|---|---|
| Of MSs | 0 | 1 | 2 | 3 | 4 | 5 | 6 |
| 3 | 96 | 49 | 13 | 3 | 1 | 0 | 0 |
| 5 | 100 | 67 | 20 | 4 | 1 | 0 | 0 |
| 10 | 100 | 89 | 36 | 9 | 2 | 0 | 0 |
| 20 | 100 | 99 | 59 | 16 | 4 | 1 | 0 |
| 30 | 100 | 100 | 74 | 23 | 5 | 1 | 0 |

In Table 3, for the target FER of 20%, the automatic retransmission number is 2 for 3 and 5 MSs, 3 for 10 and 20 MSs, and 4 for 30 MSs.

In accordance with a fourth exemplary embodiment of the present invention, if the target FER is 30%, Pr(NACK) is given in Table 3, for numbers of selected MSs based on CQI and retransmission numbers.

TABLE 4
Target FER 30%

(%)

| Number | Retransmission number | | | | | | | | |
|---|---|---|---|---|---|---|---|---|---|
| Of MSs | 0 | 1 | 2 | 3 | 4 | 5 | 6 | 7 | 8 |
| 3 | 97 | 66 | 27 | 9 | 3 | 1 | 0 | 0 | 0 |
| 5 | 100 | 83 | 41 | 15 | 5 | 1 | 0 | 0 | 0 |
| 10 | 100 | 97 | 66 | 27 | 9 | 3 | 1 | 0 | 0 |
| 20 | 100 | 100 | 88 | 47 | 18 | 6 | 2 | 1 | 0 |
| 30 | 100 | 100 | 96 | 62 | 25 | 8 | 3 | 1 | 0 |

In Table 4, for the target FER of 30%, the automatic retransmission number is 2 for 3 MSs, 3 for 5 and 10 MSs, and 4 for 20 and 30 MSs.

The above described exemplary embodiments determined the automatic retransmission number according to the total number of MSs in a multicast group on the assumption that all MSs of the multicast group are in the same channel status and exemplary results were given in Table 1 to Table 4. In another exemplary embodiment, the automatic retransmission number is determined according to the number of MSs in poor channel status selected at a predetermined ratio or the number of MSs that do not meet a reference channel status value, when MSs have different channel statuses in the multicast group.

In an exemplary embodiment of the present invention, the BS determines an automatic retransmission number referring to a table that lists automatic retransmission numbers with respect to number of MSs selected based on CQI and target FERs, which is derived from Table 1 to Table 4. The BS repeats transmission of data as many times as the determined retransmission number. The table can be given as Table 5. In Table 5, the number of MSs can be determined according to the channel statuses of MSs in the multicast group, as stated before.

TABLE 5
(number)

FER

| Number Of MSs | 1% | 10% | 20% | 30% |
|---|---|---|---|---|
| 3 | 2 | 2 | 2 | 2 |
| 5 | 2 | 2 | 2 | 3 |
| 10 | 2 | 2 | 3 | 3 |
| 20 | 2 | 3 | 3 | 4 |
| 30 | 2 | 3 | 4 | 4 |

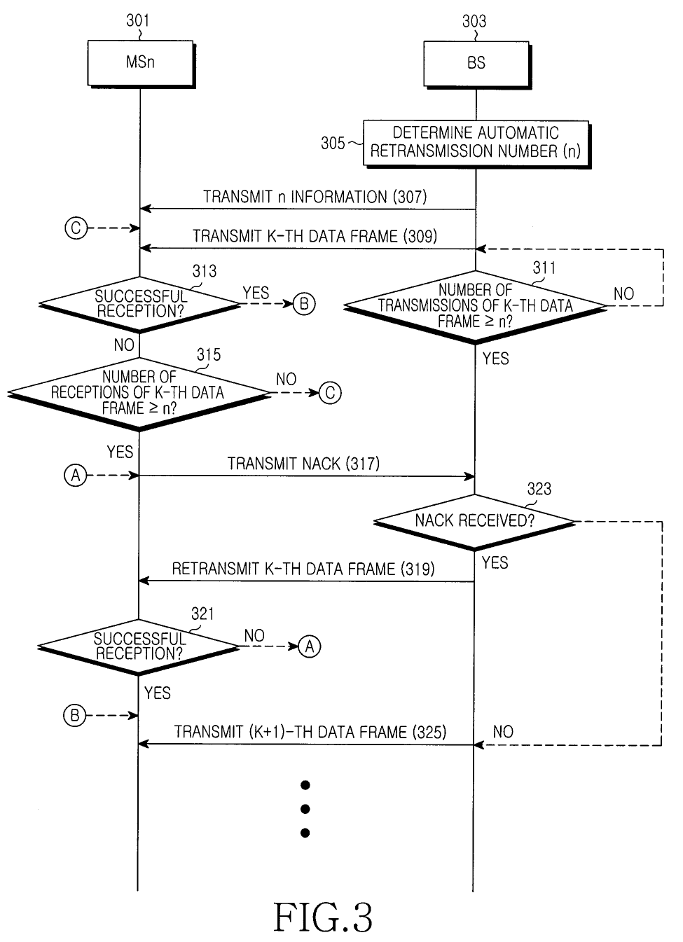

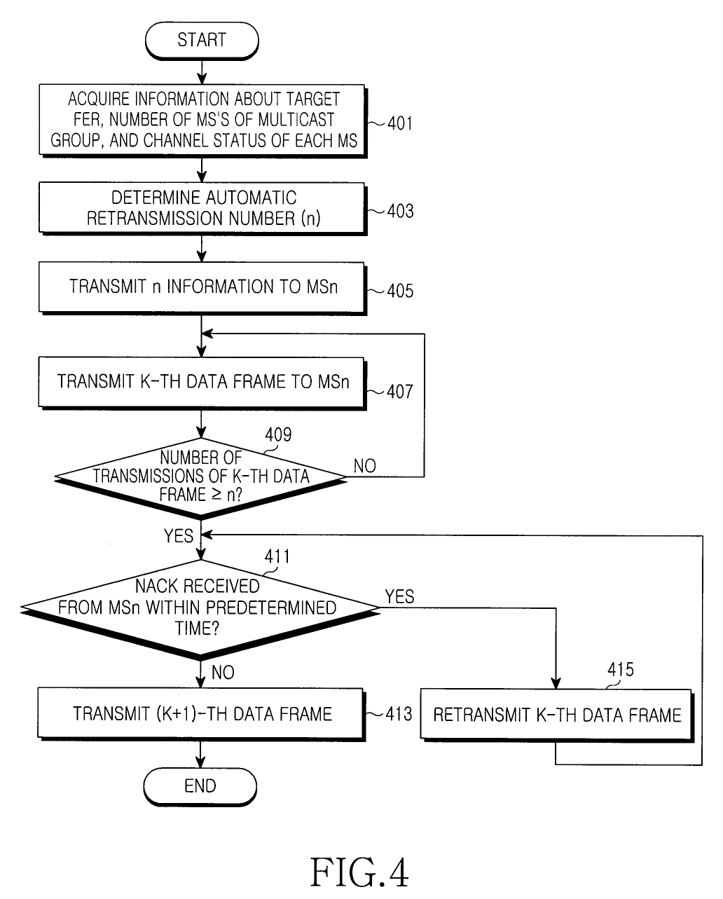

With reference to FIGS. 3 and 4, a data retransmission operation of a BS in a multicast communication system according to an exemplary embodiment of the present invention will be described. In the following description, a group of particular MSs to which the BS transmits the same data frame simultaneously is defined as a multicast group. While only a single MS is shown in FIG. 3 for convenience sake, it is to be appreciated that the MS can be any of the MSs within the multicast group and thus it is denoted by MSn.

FIG. 3 is a diagram illustrating a signal flow for a data frame retransmission operation of a BS in a multicast communication system according to an exemplary embodiment of the present invention.

Referring to FIG. 3, a BS 303 determines an automatic retransmission number n using the above-described table (i.e. Table 5) in step 305 and notifies an MS 301 (MSn) of the determined automatic retransmission number n in step 307. The BS 303 transmits a K^{th} data frame n times to MSn in step 309 and compares the number of transmissions of the K^{th} data frame with n in step 311. If the number of transmissions of the K^{th} data frame is less than n, the BS 303 retransmits the K^{th} data frame to MSn in step 309. The BS 303 repeats transmission of the K^{th} data frame until the number of transmissions of the K^{th} data frame is equal to n.

In step 313, MSn determines whether the K^{th} data frame has been received successfully. The determination as to successful reception of the K^{th} data frame involves a determination as to whether the K^{th} data frame has been received and an error check in the K^{th} data frame, upon receipt of the K^{th} data frame. The error check can be performed using a CRC.

Upon successful reception of the K^{th} data frame in step 313, MSn awaits reception of the next data frame, that is a (K+1)^{th} data frame. On the contrary, if MSn has failed to receive the K^{th} data frame, it compares the number of receptions of the K^{th} data frame with n in step 315. If the number of receptions of the K^{th} data frame is equal to or larger than n, MSn transmits a NACK signal for the K^{th} data frame to the BS 303, requesting retransmission of the K^{th} data frame in step 317. Meanwhile, the BS 303, after having determined in step 311 that the K^{th} data frame has been transmitted n or more times, proceeds to step 323 where it determines if a NACK signal is received. In the illustrated example in which the MSn 301 has transmitted a NACK signal, the BS 303 determines in step 323 that the NACK is received. Then the BS 303 retransmits the K^{th} data frame to MSn in step 319 and MSn determines whether the retransmitted K^{th} data frame has been received successfully in step 321. If the reception of the retransmitted K^{th} data frame is successful, MSn awaits reception of the next data frame, i.e. the (K+1)^{th} data frame. If the reception of the retransmitted K^{th} data frame is not successful, the MSn returns to step 317 and transmits another NACK signal to BS 303. If the BS 303 determines that it has not received a NACK signal for the K^{th} data frame in step 323, it transmits the (K+1)^{th} data frame in step 325, considering that MSn received the K^{th} data frame successfully.

On the other hand, if the number of receptions of the K^{th} data frame is less than n in step 315, MSn awaits reception of the K^{th} data frame from the BS 303.

In the illustrated example of FIG. 3, the BS 303 does not receive an ACK signal from MSn. In other words, if the BS 303 does not receive a NACK signal from MSn for a time period set by the system, it transmits the next data frame, i.e. the (K+1)^{th} data frame to MSn, considering that MSn has received the K^{th} data frame successfully. Yet, it is to be clearly understood that when receiving an ACK signal from MSn, the BS 303 may also transmit the (K+1)^{th} data frame to MSn.

FIG. 4 is a flowchart illustrating a data frame retransmission operation of a BS in a multicast communication system according to an exemplary embodiment of the present invention.

Referring to FIG. 4, the BS determines a target FER, the number of MSs, and the channel statuses of the MSs in step 401. Based on the target FER, the number of MSs, and the channel statuses of the MSs determined, the BS determines an automatic retransmission number n in step 403. In step 405, the BS notifies MSn (i.e. all MSs of a multicast group) of the automatic retransmission number n.

The BS transmits a K^{th} data frame to MSn in step 407 and compares the number of transmissions of the K^{th} data frame with n in step 409. If the number of transmissions of the K^{th} data frame is less than n, the BS returns to step 407 and transmits again the K^{th} data frame. If the number of transmissions of the K^{th} data frame is equal to or larger than n, the BS monitors for reception of a NACK signal from MSn for a time period in step 411. The time period of step 411 may be previously set by the system or may be adjusted based on channel or other system conditions. Upon receipt of a NACK signal within the time period, the BS retransmits the K^{th} data frame to MSn in step 415 and returns to step 411.

If the BS has not received a NACK signal within the time period in step 411, it transmits the next data frame, i.e. a (K+1)^{th} data frame to MSn in step 413.

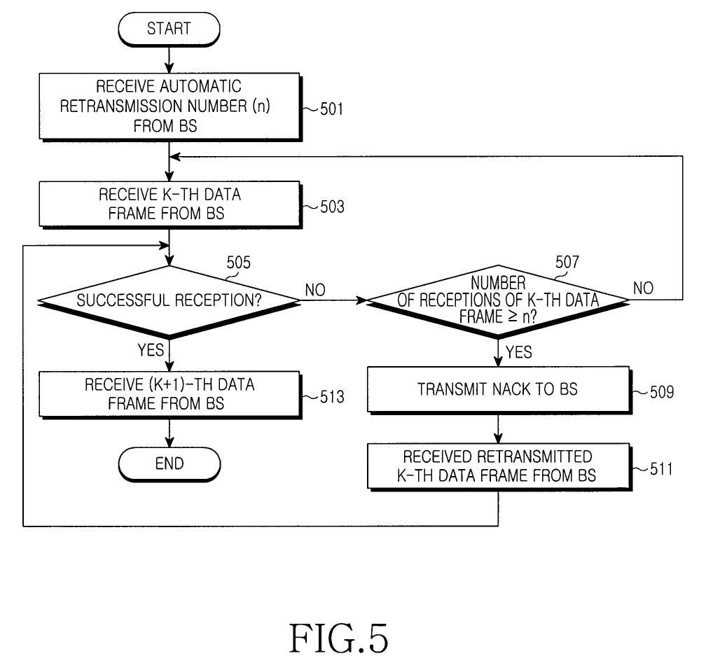

FIG. 5 is a flowchart illustrating a data reception operation of MSn in a multicast communication system according to an exemplary embodiment of the present invention.

Referring to FIG. 5, MSn receives an automatic retransmission number n from the BS in step 501 and receives a K^{th} data frame from the BS in step 503. In step 505, MSn determines whether the K^{th} data frame has been received successfully. If the K^{th} data frame has been received successfully, MSn receives the next data frame, i.e. a (K+1)^{th} data frame from the BS in step 513. On the other hand, if MSn has failed to receive the K^{th} data frame, it compares the number of receptions of the K^{th} data frame with n in step 507.

If the number of receptions of the K^{th} data frame is equal to or larger than n, MSn transmits a NACK signal to the BS in step 509, receives a retransmitted K^{th} data frame from the BS in step 511, and returns to step 505. If the number of receptions of the K^{th} data frame is less than n, MSn returns to step 503 and awaits reception of the K^{th} data frame from the BS.

As is apparent from the above description, exemplary embodiments of the present invention advantageously address the problem of a time delay caused by waiting for a NACK signal and minimize the resulting resource consumption because a data frame is automatically retransmitted according to a predetermined retransmission number irrespective of reception of the NACK signal in a communication system. Also, the overhead from transmitting NACK signals can be reduced.

While the invention has been shown and described with reference to certain exemplary embodiments of the present invention thereof, it will be understood by those skilled in the art that various changes in form and details may be made therein without departing from the spirit and scope of the present invention as defined by the appended claims and their equivalents.

What is claimed is:

1. A method for transmitting data in a Base Station (BS) in a communication system, the method comprising:
determining an automatic retransmission number for a multicast data frame according to the number of Mobile Stations (MSs) of a multicast group;
transmitting the determined automatic retransmission number to the MSs of the multicast group; and
repeatedly transmitting the multicast data frame to the MSs until the number of transmissions of the multicast data frame is equal to the automatic retransmission number.

2. The method of claim 1, wherein the repeatedly transmitting of the multicast data frame further comprises retransmitting the multicast data frame irrespective of reception of information from at least one of the MSs indicating that the multicast data frame has been received.

3. The method of claim 1, wherein the determining of the automatic retransmission number comprises:
calculating probabilities of receiving a Negative ACKnowledgment (NACK) signal corresponding to numbers of MSs selected from the multicast group and repeated transmission numbers, taking into account a target data error rate, the number of the MSs of the multicast group, and channel statuses of the MSs of the multicast group; and
selecting, as the automatic retransmission number, a repeated transmission number corresponding to a maximum of probabilities that is equal to or less than the target data error rate.

4. The method of claim 3, wherein the calculating of the probability of receiving a NACK signal comprises using the following equation,
Pr(NACK)=1−(1−ρ)^{ρ}^{^{n−1}}^{K}
where ρ is the target data error rate, n is the repeated transmission number, and K is the number of selected MSs.

5. The method of claim 4, wherein the MSs are selected according to channel quality information.

6. The method of claim 4, wherein the target data error rate comprises at least one of a Frame Error Rate (FER), a Bit Error Rate (BER), and a Symbol Error Rate (SER).

7. The method of claim 1, further comprising transmitting a next multicast data frame to the MSs when a NACK signal is not received from the MSs within a time period after repeated transmission of the multicast data frame.

8. The method of claim 1, further comprising retransmitting the multicast data frame to the MSs, upon receipt of a NACK signal from at least one of the MSs after repeated transmission of the multicast data frame.

9. A method for receiving data in a Mobile Station (MS) in a communication system, the method comprising:
receiving an automatic retransmission number from a Base Station (BS);
receiving a multicast data frame repeatedly from the BS and discontinuing transmitting information indicating that the multicast data frame has been received; and
transmitting, after receiving the multicast data frame repeatedly until the number of receptions of the multicast data frame is equal to the automatic retransmission number, a Negative ACKowledgment (NACK) signal to the BS if the reception of the multicast data frame is not successful.

10. A communication system, comprising:
a Base Station (BS) for determining an automatic retransmission number for a multicast data frame according to the number of Mobile Stations (MSs) of a multicast group, transmitting the determined automatic retransmission number to the MSs of the multicast group, and repeatedly transmitting the multicast data frame to the MSs until the number of transmissions of the multicast data frame is equal to the automatic retransmission number; and
the MSs of the multicast group.

11. The system of claim 10, wherein the BS repeatedly transmits the multicast data frame irrespective of reception of information from at least one of the MSs indicating that the multicast data frame has been received.

12. The system of claim 10, wherein the MSs receive the automatic retransmission number from the BS, receive the multicast data frame repeatedly from the BS, discontinues transmitting information indicating that the multicast data frame has been received and transmit a Negative ACKnowledgment (NACK) signal to the BS if the reception of the multicast data frame is not successful, after receiving the multicast data frame repeatedly until the number of receptions of the multicast data frame is equal to the automatic retransmission number.

13. The system of claim 10, wherein the BS calculates probabilities of receiving a NACK signal corresponding to numbers of MSs selected from the multicast group and repeated transmission numbers, taking into account a target data error rate, the number of the MSs of the multicast group, and channel statuses of the MSs of the multicast group, and selects, as the automatic retransmission number, a repeated transmission number corresponding to a maximum of probabilities that is equal to or less than the target data error rate.

14. The system of claim 13, wherein the probability of receiving a NACK signal is calculated by the following equation,
Pr(NACK)=1−(1−ρ)^{ρ}^{^{n−1}}^{K}
where ρ is the target data error rate, n is the repeated transmission number, and K is the number of selected MSs.

15. The system of claim 14, wherein the MSs are selected according to channel quality information.

16. The system of claim 14, wherein the target data error rate comprises at least one of a Frame Error Rate (FER), a Bit Error Rate (BER), and a Symbol Error Rate (SER).

17. The system of claim 10, wherein the BS transmits a next multicast data frame to the MSs, when a NACK signal is not received from the MSs within a time period after repeated transmission of the multicast data frame.

18. The system of claim 10, wherein the BS retransmits the multicast data frame to the MSs, upon receipt of a NACK signal from at least one of the MSs after repeated transmission of the multicast data frame.
